(19) United States
(12) Patent Application Publication
(10) Pub. No.: US 2021/0183362 A1
(43) Pub. Date: Jun. 17, 2021

(54) INFORMATION PROCESSING DEVICE, INFORMATION PROCESSING METHOD, AND COMPUTER-READABLE STORAGE MEDIUM

(71) Applicant: Mitsubishi Electric Corporation, Tokyo (JP)

(72) Inventors: Yusuke KOJI, Tokyo (JP); Wen WANG, Tokyo (JP); Yohei OKATO, Tokyo (JP); Takeyuki AIKAWA, Tokyo (JP)

(73) Assignee: Mitsubishi Electric Corporation, Tokyo (JP)

(21) Appl. No.: 17/181,729

(22) Filed: Feb. 22, 2021

Related U.S. Application Data
(63) Continuation of application No. PCT/JP2018/032379, filed on Aug. 31, 2018.

(51) Int. Cl. G10L 15/00; G10L 25/51; G10L 25/78; G06F 17/18

(52) U.S. Cl. CPC G10L 15/00; G06F 17/18; G10L 25/78; G10L 25/51

(57) ABSTRACT

An information processing device includes processing circuitry to acquire a signal representing voices corresponding to utterances made by one or more users; recognize the voices from the signal, convert the recognized voices into character strings to identify the utterances, and identify times corresponding to the utterances; identify users who have made the utterances, as speakers from among the users; store information including records indicating the utterances, the times corresponding to the utterances, and the speakers corresponding to the utterances; estimate meanings of the utterances; refer to the information and when a last utterance of the utterances and one or more of the utterances immediately preceding the last utterance are not a conversation, determine that the last utterance is a voice command for controlling a target; and when it is determined that the last utterance is the voice command, control the target in accordance with the meaning of the last utterance.

### CROSS REFERENCE TO RELATED APPLICATION

This application is a continuation of International Application No. PCT/JP2018/032379, filed on Aug. 31, 2018, the disclosure of which is incorporated herein by reference in its entirety.

### BACKGROUND OF THE INVENTION

### 1. Field of the Invention

The present invention relates to an information processing device, an information processing method, and a computer-readable storage medium.

### 2. Description of the Related Art

Conventionally, in operating an automotive navigation system through voice recognition, it is most common for a driver to explicitly perform an operation, such as pressing an utterance switch, to issue a command to start the voice recognition. However, performing such an operation whenever using the voice recognition is troublesome, and it is preferable to make it possible to use the voice recognition without explicitly issuing a command to start the voice recognition.

Patent Literature 1 describes a voice recognition device that sets a driver as a voice command input target, includes a first determination means for determining the presence or absence of an utterance made by the driver, by using a sound direction and an image, and a second determination means for determining the presence or absence of an utterance of a fellow passenger, and determines to start voice command recognition, by using the fact that the driver has uttered.

In the voice recognition device described in Patent Literature 1, by requiring, as a condition for starting the voice command recognition, that no fellow passengers utter immediately after the driver utters, it is possible, even when there are fellow passengers in the vehicle, to distinguish whether the driver is talking to another person or uttering to a microphone for voice input.

Patent Literature 1: Japanese Patent Application Publication No. 2007-219207

However, the voice recognition device described in Patent Literature 1 has a problem in that, in a case where a fellow passenger in a passenger seat is talking on the phone or talking with another fellow passenger, even when the driver speaks to the automotive navigation system, the voice of the driver is not recognized, and thus the voice command of the driver cannot be executed.

Specifically, the voice recognition device described in Patent Literature 1 cannot execute voice commands of the driver in the following first and second cases:

First case: The driver utters a command while a fellow passenger in a passenger seat is talking with another fellow passenger in a rear seat.

Second case: The driver utters a command while a fellow passenger in a passenger seat is talking on the phone.

### SUMMARY OF THE INVENTION

Thus, one or more aspects of the present invention are intended to make it possible, even when there are multiple users, to determine whether an utterance made by a certain user is an utterance to input a voice command.

An information processing device according to an aspect of the present invention includes processing circuitry to acquire a voice signal representing voices corresponding to a plurality of utterances made by one or more users; to recognize the voices from the voice signal, convert the recognized voices into character strings to identify the plurality of utterances, and identify times corresponding to the respective utterances; to identify users who have made the respective utterances, as speakers from among the one or more users; to store utterance history information including a plurality of records, the plurality of records indicating the respective utterances, the times corresponding to the respective utterances, and the speakers corresponding to the respective utterances; to estimate meanings of the respective utterances; to perform a determination process of referring to the utterance history information and when a last utterance of the plurality of utterances and one or more utterances of the plurality of utterances immediately preceding the last utterance are not a conversation, determining that the last utterance is a voice command for controlling a target; and to, when it is determined that the last utterance is the voice command, control the target in accordance with the meaning estimated from the last utterance.

An information processing method according to an aspect of the present invention includes: acquiring a voice signal representing voices corresponding to a plurality of utterances made by one or more users; recognizing the voices from the voice signal; converting the recognized voices into character strings to identify the plurality of utterances; identifying times corresponding to the respective utterances; identifying users who have made the respective utterances, as speakers from among the one or more users; estimating meanings of the respective utterances; referring to utterance history information including a plurality of records, the plurality of records indicating the respective utterances, the times corresponding to the respective utterances, and the speakers corresponding to the respective utterances, and when a last utterance of the plurality of utterances and one or more utterances of the plurality of utterances immediately preceding the last utterance are not a conversation, determining that the last utterance is a voice command for controlling a target; and when it is determined that the last utterance is the voice command, controlling the target in accordance with the meaning estimated from the last utterance.

A non-transitory computer-readable storage medium according to an aspect of the present invention stores a program for causing a computer to acquire a voice signal representing voices corresponding to a plurality of utterances made by one or more users; to recognize the voices from the voice signal, convert the recognized voices into character strings to identify the plurality of utterances, and identify times corresponding to the respective utterances; to identify users who have made the respective utterances, as speakers from among the one or more users; to store utterance history information including a plurality of records, the plurality of records indicating the respective utterances, the times corresponding to the respective utterances, and the speakers corresponding to the respective utterances; to estimate meanings of the respective utterances; to perform a determination process of referring to the utterance history information and when a last utterance of the plurality of utterances and one or more utterances of the plurality of utterances immediately preceding the last utterance are not a conversation, determining that the last utterance is a voice command for controlling a target; and to, when it is determined that the last utterance is the voice command, control the target in accordance with the meaning estimated from the last utterance.

With one or more aspects of the present invention, it is possible, even when there are multiple users, to determine whether an utterance made by a certain user is an utterance to input a voice command.

### BRIEF DESCRIPTION OF DRAWINGS

FIG. 1 is a block diagram schematically illustrating a configuration of a meaning understanding device according to a first embodiment.

FIG. 2 is a block diagram schematically illustrating a configuration of a command determination unit of the first embodiment.

FIG. 3 is a block diagram schematically illustrating a configuration of a context matching rate estimation unit of the first embodiment.

FIG. 4 is a block diagram schematically illustrating a configuration of a conversation model training unit of the first embodiment.

FIG. 5 is a block diagram schematically illustrating a first example of the hardware configuration of the meaning understanding device.

FIG. 6 is a block diagram schematically illustrating a second example of the hardware configuration of the meaning understanding device.

FIG. 7 is a flowchart illustrating the operation of a meaning estimation process by the meaning understanding device of the first embodiment.

FIG. 8 is a schematic diagram illustrating an example of utterance history information.

FIG. 9 is a flowchart illustrating the operation of a command determination process for an automotive navigation system of the first embodiment.

FIG. 10 is a flowchart illustrating the operation of a context matching rate estimation process.

FIG. 11 is a schematic diagram illustrating a first calculation example of a context matching rate.

FIG. 12 is a schematic diagram illustrating a second calculation example of the context matching rate.

FIG. 13 is a flowchart illustrating the operation of a process of training a conversation model.

FIG. 14 is a schematic diagram illustrating an example of designating a conversation.

FIG. 15 is a schematic diagram illustrating an example of generating training data.

FIG. 16 is a block diagram schematically illustrating a configuration of a meaning understanding device according to a second embodiment.

FIG. 17 is a block diagram schematically illustrating a configuration of a command determination unit of the second embodiment.

FIG. 18 is a schematic diagram illustrating an example of an utterance group identified as a first pattern.

FIG. 19 is a schematic diagram illustrating an example of an utterance group identified as a second pattern.

FIG. 20 is a schematic diagram illustrating an example of an utterance group identified as a third pattern.

FIG. 21 is a schematic diagram illustrating an example of an utterance group identified as a fourth pattern.

FIG. 22 is a block diagram schematically illustrating a configuration of a context matching rate estimation unit of the second embodiment.

FIG. 23 is a block diagram schematically illustrating a configuration of a conversation model training unit of the second embodiment.

FIG. 24 is a flowchart illustrating the operation of a meaning estimation process by the meaning understanding device according to the second embodiment.

FIG. 25 is a flowchart illustrating the operation of a command determination process for an automotive navigation system of the second embodiment.

### DETAILED DESCRIPTION OF THE INVENTION

The following embodiments describe examples in which meaning understanding devices as information processing devices are applied to automotive navigation systems.

### First Embodiment

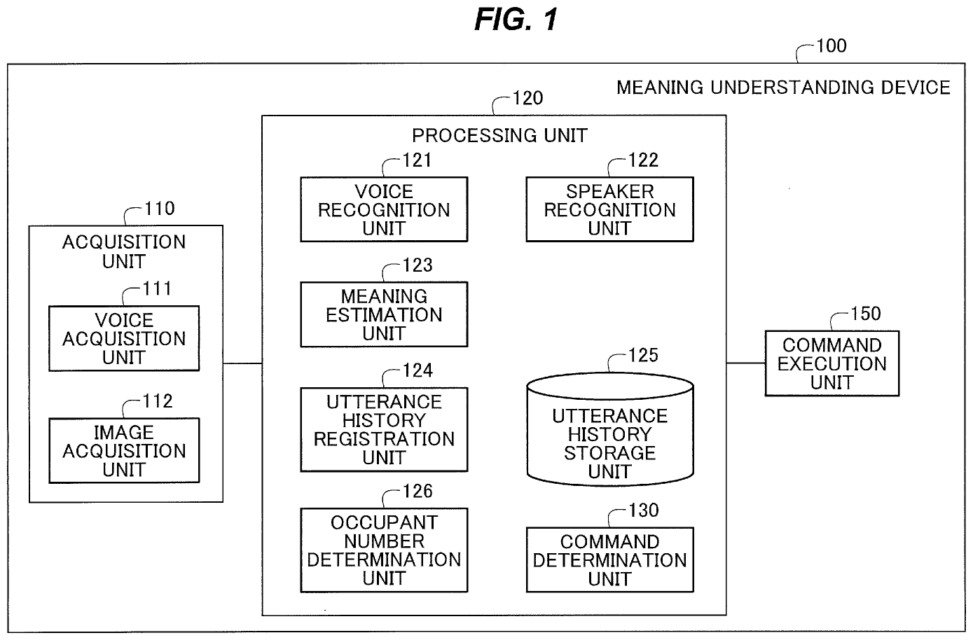

FIG. 1 is a block diagram schematically illustrating a configuration of a meaning understanding device 100 according to a first embodiment.

The meaning understanding device 100 includes an acquisition unit 110, a processing unit 120, and a command execution unit 150.

The acquisition unit 110 is an interface that acquires a voice and an image.

The acquisition unit 110 includes a voice acquisition unit 111 and an image acquisition unit 112.

The voice acquisition unit 111 acquires a voice signal representing voices corresponding to multiple utterances made by one or more users. For example, the voice acquisition unit 111 acquires a voice signal from a voice input device (not illustrated), such as a microphone.

The image acquisition unit 112 acquires an image signal representing an image of a space in which the one or more users exist. For example, the image acquisition unit 112 acquires an image signal representing an imaged image, from an image input device (not illustrated), such as a camera. Here, the image acquisition unit 112 acquires an image signal representing an in-vehicle image that is an image inside a vehicle (not illustrated) provided with the meaning understanding device 100.

The processing unit 120 uses a voice signal and an image signal from the acquisition unit 110 to determine whether an utterance from a user is a voice command for controlling an automotive navigation system that is a target.

The processing unit 120 includes a voice recognition unit 121, a speaker recognition unit 122, a meaning estimation unit 123, an utterance history registration unit 124, an utterance history storage unit 125, an occupant number determination unit 126, and a command determination unit 130.

The voice recognition unit 121 recognizes a voice represented by a voice signal acquired by the voice acquisition unit 111, converts the recognized voice into a character string to identify an utterance from a user. Then, the voice recognition unit 121 generates an utterance information item indicating the identified utterance.

Also, the voice recognition unit 121 identifies a time corresponding to the identified utterance, e.g., a time at which the voice corresponding to the utterance was recognized. Then, the voice recognition unit 121 generates a time information item indicating the identified time.

It is assumed that the voice recognition in the voice recognition unit 121 uses a known technique. For example, the voice recognition processing can be implemented by using the technique described in Kiyohiro Shikano, Katsunobu Ito, Tatsuya Kawahara, Kazuya Takeda, Mikio Yamamoto, “IT Text Voice Recognition System”, Ohmsha Ltd., 2001, Chapter 3 (pp. 43-50).

Specifically, a voice may be recognized by using a hidden Markov model (HMM) that is a statistical model of time series trained for each phoneme, to output a sequence of features of an observed voice with the highest probability.

The speaker recognition unit 122 identifies, from the voice represented by the voice signal acquired by the voice acquisition unit 111, the user who has made the utterance as a speaker. Then, the speaker recognition unit 122 generates a speaker information item indicating the identified speaker.

It is assumed that the speaker identification processing in the speaker recognition unit 122 uses a known technique. For example, the speaker identification processing can be implemented by using the technique described in Sadaoki Yoshii, “Voice Information Processing”, Morikita Publishing Co., Ltd., 1998, Chapter 6 (pp. 133-146).

Specifically, it is possible to previously register standard patterns of voices of multiple speakers and select the speaker corresponding to one of the registered standard patterns having the highest similarity (likelihood).

The meaning estimation unit 123 estimates, from the utterance indicated by the utterance information item generated by the voice recognition unit 121, a meaning of the user.

Here, it is assumed that the meaning estimation method uses a known technique relating to text classification. For example, the meaning estimation processing can be implemented by using the text classification technique described in Pang-ning Tan, Michael Steinbach, Vipin Kumar, “Introduction To Data Mining”, Person Education, Inc, 2006, Chapter 5 (pp. 256-276).

Specifically, it is possible to obtain lines for classifying multiple classes (meanings) from training data by using a support vector machine (SVM), and classify the utterance indicated by the utterance information item generated by the voice recognition unit 121 as one of the classes (meanings).

The utterance history registration unit 124 registers, in utterance history information stored in the utterance history storage unit 125, the utterance indicated by the utterance information item generated by the voice recognition unit 121, the time indicated by the time information item corresponding to the utterance information item, and the speaker indicated by the speaker information item corresponding to the utterance information item, as a record.

The utterance history storage unit 125 stores the utterance history information, which includes multiple records. Each of the records indicates an utterance, the time corresponding to the utterance, and the speaker corresponding to the utterance.

The occupant number determination unit 126 is a person number determination unit that determines the number of occupants by using an in-vehicle image represented by an image signal from the image acquisition unit 112.

It is assumed that the person number determination in the occupant number determination unit 126 uses a known technique for face recognition. For example, the occupant number determination processing can be implemented by using the face recognition technique described in Koichi Sakai, “Introduction to Image Processing and Pattern Recognition”, Morikita Publishing Co., Ltd., 2006, Chapter 7 (pp. 119-122).

Specifically, it is possible to recognize the faces of occupants by face image pattern matching, thereby determining the number of occupants.

The command determination unit 130 determines whether the currently input user's utterance is a voice command for the automotive navigation system, by using the utterance information item generated by the voice recognition unit 121, the speaker information item generated by the speaker recognition unit 122, and one or more immediately preceding records in the utterance history information stored in the utterance history storage unit 125.

Specifically, the command determination unit 130 refers to the utterance history information and determines whether the last utterance of the multiple utterances, i.e., the utterance indicated by the utterance information item, and one or more utterances of the multiple utterances immediately preceding the last utterance are a conversation. When the command determination unit 130 determines that they are not a conversation, it determines that the last utterance is a voice command for controlling the target.

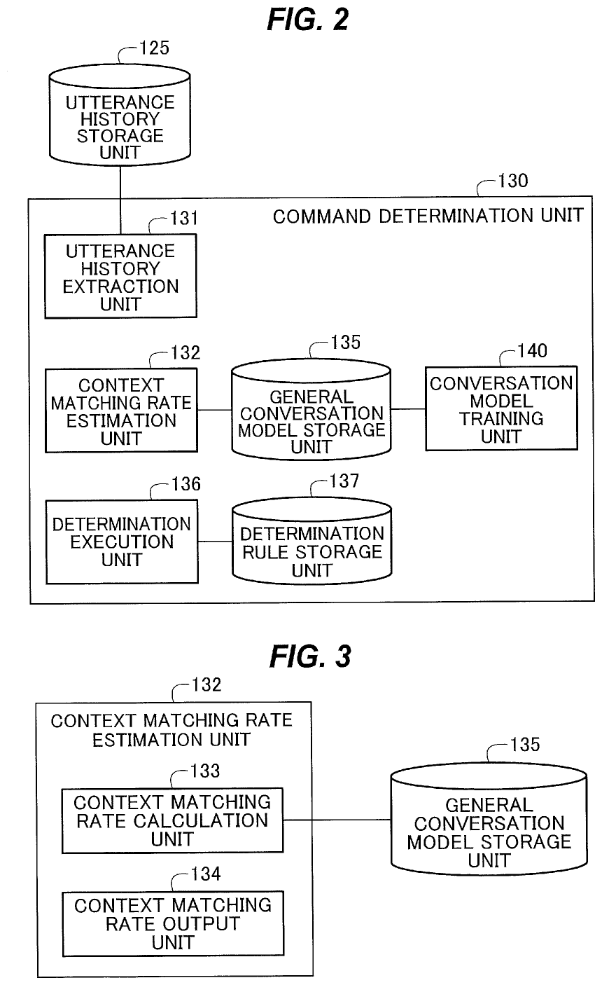

FIG. 2 is a block diagram schematically illustrating a configuration of the command determination unit 130.

The command determination unit 130 includes an utterance history extraction unit 131, a context matching rate estimation unit 132, a general conversation model storage unit 135, a determination execution unit 136, a determination rule storage unit 137, and a conversation model training unit 140.

The utterance history extraction unit 131 extracts, from the utterance history information stored in the utterance history storage unit 125, one or more records immediately preceding the last utterance.

The context matching rate estimation unit 132 estimates a context matching rate between the current user's utterance that is the last utterance and the utterances included in the records extracted from the utterance history storage unit 125, by using general conversation model information stored in the general conversation model storage unit 135. The context matching rate indicates the degree of matching between the utterances in terms of context. Thus, when the context matching rate is high, it can be determined that a conversation is being conducted, and when the context matching rate is low, it can be determined that no conversation is being conducted.

FIG. 3 is a block diagram schematically illustrating a configuration of the context matching rate estimation unit 132.

The context matching rate estimation unit 132 includes a context matching rate calculation unit 133 and a context matching rate output unit 134.

The context matching rate calculation unit 133 calculates the context matching rate between the utterance input to the voice acquisition unit 111 and the utterances included in the immediately preceding records in the utterance history information stored in the utterance history storage unit 125, with reference to the general conversation model information stored in the general conversation model storage unit 135.

The calculation of the context matching rate in the context matching rate calculation unit 133 can be implemented by the encoder-decoder model technique described in Ilya Sutskever, Oriol Vinyals, Quoc V. le, “Sequence to Sequence Learning with Neural Networks” (Advances in neural information processing systems), 2014.

Specifically, it is possible to set the utterances included in the immediately preceding records from the utterance history information as an input sentence X and the utterance input to the voice acquisition unit 111 as an output sentence Y, calculate the probability P(Y|X) that the input sentence X leads to the output sentence Y according to a Long short-Term Memory-Language Model (LSTM-LM) formula by using the general conversation model information, which has been trained, and determine the probability P as the context matching rate.

That is, the context matching rate calculation unit 133 calculates, as the context matching rate, the probability that the immediately preceding utterances lead to the current user's utterance.

The context matching rate output unit 134 provides the probability P calculated by the context matching rate calculation unit 133, as the context matching rate, to the determination execution unit 136.

Returning to FIG. 2, the general conversation model storage unit 135 stores the general conversation model information, which represents a general conversation model that is a conversation model trained on general conversations conducted by multiple users.

The determination execution unit 136 determines whether the current user's utterance is a command for the automotive navigation system, according to a determination rule stored in the determination rule storage unit 137.

The determination rule storage unit 137 is a database that stores the determination rule for determining whether the current user's utterance is a command for the automotive navigation system.

The conversation model training unit 140 trains the conversation model from general conversations.

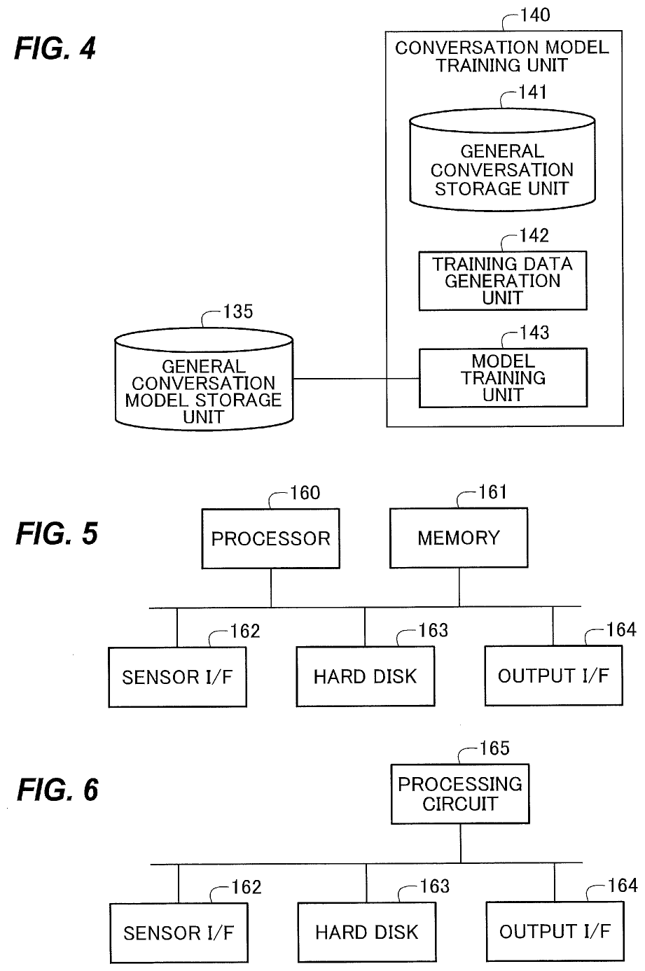

FIG. 4 is a block diagram schematically illustrating a configuration of the conversation model training unit 140.

The conversation model training unit 140 includes a general conversation storage unit 141, a training data generation unit 142, and a model training unit 143.

The general conversation storage unit 141 stores general conversation information representing conversations generally conducted by multiple users.

The training data generation unit 142 separates last utterances and immediately preceding utterances from the general conversation information stored in the general conversation storage unit 141, thereby converting it into a format of training data.

The model training unit 143 trains an encoder-decoder model by using the training data generated by the training data generation unit 142 and stores, in the general conversation model storage unit 135, general conversation model information representing the trained model as a general conversation model. For the processing in the model training unit 143, the technique described in “Sequence to Sequence Learning with Neural Networks” described above may be used.

Returning to FIG. 1, the command execution unit 150 executes an operation corresponding to a voice command. Specifically, when the command determination unit 130 determines that the last utterance is a voice command, the command execution unit 150 controls the target in accordance with the meaning estimated from the last utterance.

FIG. 5 is a block diagram schematically illustrating a first example of the hardware configuration of the meaning understanding device 100.

The meaning understanding device 100 includes, for example, a processor 160, such as a central processing unit (CPU), a memory 161, a sensor interface (sensor I/F) 162 for a microphone, a keyboard, a camera, and the like, a hard disk 163 as a storage device, and an output interface (output I/F) 164 for outputting images, sounds, or commands to a speaker (audio output device) or a display (display device), which are not illustrated.

Specifically, the acquisition unit 110 can be implemented by the processor 160 using the sensor I/F 162. The processing unit 120 can be implemented by the processor 160 reading a program and data stored in the hard disk 163 into the memory 161 and executing and using them. The command execution unit 150 can be implemented by the processor 160 reading the program and data stored in the hard disk 163 into the memory 161 and executing and using them and outputting, as needed, images, sounds, or commands to other devices through the output I/F 164.

Such a program may be provided through a network, or may be recorded and provided in a recording medium. Thus, such a program may be provided as a program product, for example.

FIG. 6 is a block diagram schematically illustrating a second example of the hardware configuration of the meaning understanding device 100.

Instead of the processor 160 and memory 161 illustrated in FIG. 5, a processing circuit 165 may be provided, as illustrated in FIG. 6.

The processing circuit 165 may be formed by a single circuit, a composite circuit, a programmed processor, a parallel-programmed processor, an application specific integrated circuit (ASIC), a field programmable gate array (FPGA), or the like.

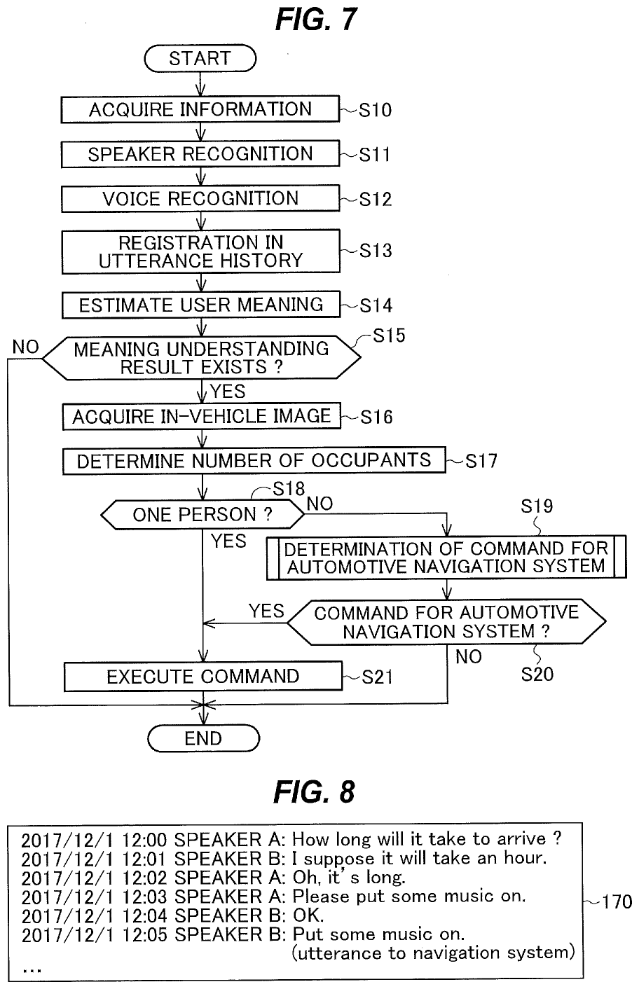

FIG. 7 is a flowchart illustrating the operation of a meaning estimation process by the meaning understanding device 100.

First, the voice acquisition unit 111 acquires a voice signal representing a voice uttered by a user through a microphone (not illustrated) (S10). The voice acquisition unit 111 provides the voice signal to the processing unit 120.

Then, the speaker recognition unit 122 performs a speaker recognition process on the voice signal (S11). The speaker recognition unit 122 provides a speaker information item indicating the identified speaker to the utterance history registration unit 124 and command determination unit 130.

Then, the voice recognition unit 121 recognizes the voice represented by the voice signal and converts the recognized voice into a character string, thereby generating an utterance information item indicating an utterance consisting of the converted character string and a time information item indicating the time at which the voice recognition was performed (S12). The voice recognition unit 121 provides the utterance information item and time information item to the meaning estimation unit 123, utterance history registration unit 124, and command determination unit 130. The utterance indicated by the utterance information item last generated by the voice recognition unit 121 will be referred to as the current user's utterance.

Then, the utterance history registration unit 124 registers a record indicating the utterance indicated by the utterance information item, the time indicated by the time information item corresponding to the utterance information item, and the speaker indicated by the speaker information item corresponding to the utterance information item, in the utterance history information stored in the utterance history storage unit 125 (S13).

FIG. 8 is a schematic diagram illustrating an example of the utterance history information.

The utterance history information 170 illustrated in FIG. 8 includes multiple rows, and each of the rows is a record indicating the utterance indicated by an utterance information item, the time indicated by the time information item corresponding to the utterance information item, and the speaker indicated by the speaker information item corresponding to the utterance information item.

For example, the utterance history information 170 illustrated in FIG. 8 indicates what was spoken by two speakers.

Returning to FIG. 7, the meaning estimation unit 123 then estimates a meaning of the user from the utterance information item, which is the result of the voice recognition (S14).

The meaning estimation in the meaning estimation unit 123 falls into a text classification problem. Meanings are defined in advance, and the meaning estimation unit 123 classifies the current user's utterance as one of the meanings.

For example, a current user's utterance “Turn on the air conditioner” is classified as a meaning of “TURN_ON_AIR_CONDITIONER” that indicates starting the air conditioner.

Also, a current user's utterance “It is raining today” is classified as a meaning of “UNKNOWN” that indicates that the meaning is unknown.

Thus, when the current user's utterance can be classified as a predetermined specific meaning, the meaning estimation unit 123 classifies it as the meaning, and when the current user's utterance cannot be classified as a predetermined specific meaning, the meaning estimation unit 123 classifies it as “UNKNOWN” that indicates that the meaning is unknown.

Then, the meaning estimation unit 123 determines whether the meaning estimation result is “UNKNOWN” (S15). When the meaning estimation result is not “UNKNOWN” (Yes in S15), the meaning estimation result is provided to the command determination unit 130, and the process proceeds to step S16. When the meaning estimation result is “UNKNOWN” (No in S15), the process ends.

In step S16, the image acquisition unit 112 acquires, from the camera, an image signal representing an in-vehicle image, and provides the image signal to the occupant number determination unit 126.

Then, the occupant number determination unit 126 determines, from the in-vehicle image, the number of occupants, and provides the command determination unit 130 with occupant number information indicating the determined number of occupants (S17).

Then, the command determination unit 130 determines whether the number of occupants indicated by the occupant number information is one (S18). When the number of occupants is one (Yes in S18), the process proceeds to step S21, and when the number of occupants is not one, i.e., the number of occupants is two or more (No in S18), the process proceeds to step S19.

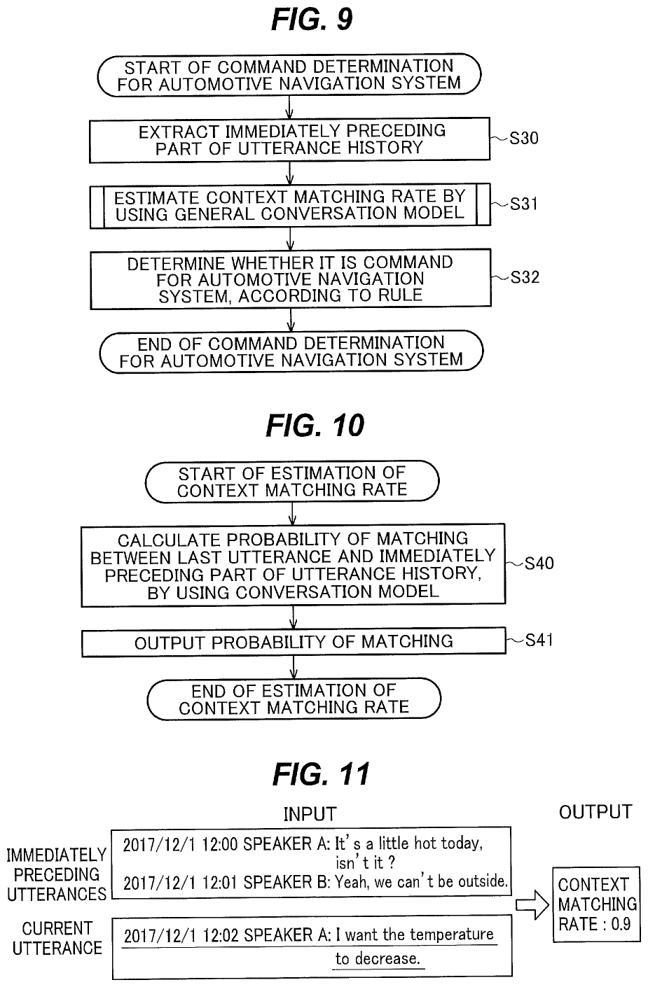

In step S19, the command determination unit 130 determines whether the meaning estimation result is a voice command that is a command for the automotive navigation system. The process in step S19 will be described in detail with reference to FIG. 9.

When the meaning estimation result is a voice command (Yes in S20), the process proceeds to step S21, and when the meaning estimation result is not a voice command (No in S20), the process ends.

In step S21, the command determination unit 130 provides the meaning estimation result to the command execution unit 150, and the command execution unit 150 executes an operation corresponding to the meaning estimation result.

For example, when the meaning estimation result is “TURN_ON_AIR_CONDITIONER”, the command execution unit 150 outputs a command to start the air conditioner in the vehicle.

FIG. 9 is a flowchart illustrating the operation of a command determination process for the automotive navigation system.

First, the utterance history extraction unit 131 extracts one or more immediately preceding records from the utterance history information stored in the utterance history storage unit 125 (S30). The utterance history extraction unit 131 extracts records, such as the records during the preceding 10 seconds or the preceding 10 records, according to a predetermined rule. Then, the utterance history extraction unit 131 provides the context matching rate estimation unit 132 with the extracted records together with the utterance information item indicating the current user's utterance.

Then, the context matching rate estimation unit 132 estimates the context matching rate between the current user's utterance and the utterances included in the immediately preceding records, by using the general conversation model information stored in the general conversation model storage unit 135 (S31). The detail of the process will be described in detail with reference to FIG. 10. The context matching rate estimation unit 132 provides the estimation result to the determination execution unit 136.

Then, the determination execution unit 136 determines whether to execute the meaning estimation result, according to the determination rule indicated by determination rule information stored in the determination rule storage unit 137 (S32).

For example, as determination rule 1, a determination rule that “when the context matching rate is greater than a threshold of 0.5, it is determined not to be a command for the navigation system” is used. According to this determination rule, when the context matching rate is not greater than 0.5, which is the threshold, the determination execution unit 136 determines that the meaning estimation result is a command for the navigation system that is a voice command, and when the context matching rate is greater than 0.5, the determination execution unit 136 determines that the meaning estimation result is not a command for the navigation system.

Also, as determination rule 2, a rule of calculating a weighted context matching rate obtained by weighting the context matching rate by using an elapsed time from the immediately preceding utterance may be used. The determination execution unit 136 can decrease the context matching rate as the elapsed time until the current user's utterance increases, by using the weighted context matching rate to perform the determination according to determination rule 1.

Determination rule 2 need not necessarily be used.

When determination rule 2 is not used, the determination can be made by comparing the context matching rate with the threshold according to determination rule 1.

On the other hand, when determination rule 2 is used, the determination can be made by comparing a value obtained by correcting the calculated context matching rate by using a weight, with the threshold.

FIG. 10 is a flowchart illustrating the operation of the context matching rate estimation process.

First, the context matching rate calculation unit 133 calculates, as the context matching rate, a possibility that is the degree of matching between the current user's utterance and the utterances included in the immediately preceding records, by using the general conversation model information stored in the general conversation model storage unit 135 (S40).

For example, as in example 1 illustrated in FIG. 11, when the current user's utterance is “I want the temperature to decrease”, the relationship with the immediately preceding utterances is strong, and thus the context matching rate is calculated to be 0.9.

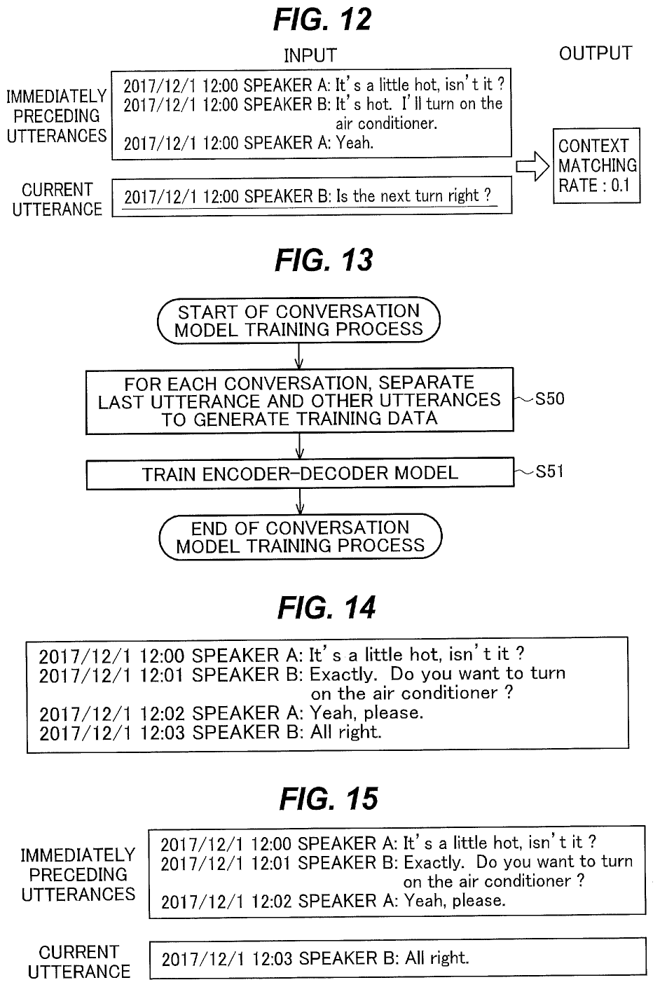

On the other hand, as in example 2 illustrated in FIG. 12, when the current user's utterance is “Is the next turn right?”, the relationship with the immediately preceding utterances is weak, and thus the context matching rate is calculated to be 0.1.

Then, the context matching rate calculation unit 133 provides the calculated context matching rate to the determination execution unit 136 (S41).

For example, when the context matching rate is 0.9 as illustrated in example 1 of FIG. 11, it is determined that the meaning estimation result is not a command for the automotive navigation system, according to determination rule 1.

On the other hand, when the context matching rate is 0.1 as illustrated in example 2 of FIG. 12, it is determined that the meaning estimation result is a command for the automotive navigation system, according to determination rule 1.

In example of FIG. 11, when the elapsed time until the current user's utterance is 4 seconds, applying determination rule 2 to example 1 of FIG. 11 results in a weighted context matching rate of ¼×0.9=0.225. In this case, it is determined to be a command for the automotive navigation system, according to determination rule 1.

FIG. 13 is a flowchart illustrating the operation of the process of training the conversation model.

First, the training data generation unit 142 extracts the general conversation information stored in the general conversation storage unit 141, and for each conversation, separates the last utterance and the other utterance(s), thereby generating training data (S50).

For example, as illustrated in FIG. 14, the training data generation unit 142 designates a conversation from the general conversation information stored in the general conversation storage unit 141.

Then, for example, as illustrated in FIG. 15, the training data generation unit 142 determines the last utterance of the conversation as a current user's utterance and the other utterances as immediately preceding utterances, thereby generating training data.

The training data generation unit 142 provides the generated training data to the model training unit 143.

Returning to FIG. 13, the model training unit 143 then generates an encoder-decoder model with the training data by using a deep learning method (S51). Then, the model training unit 143 stores, in the general conversation model storage unit 135, general model information representing the generated encoder-decoder model.

In the above embodiment, the process in the model training unit 143 has been described by taking the encoder-decoder model as the training method. However, other methods can be used. For example, it is possible to use a supervised machine learning method, such as an SVM.

However, in the case of using a general supervised machine learning method, such as an SVM, since it is necessary to attach, to training data, a label indicating whether matching in context exists, the cost of generating training data tends to be high. The encoder-decoder model is advantageous in that training data requires no label.

### Second Embodiment

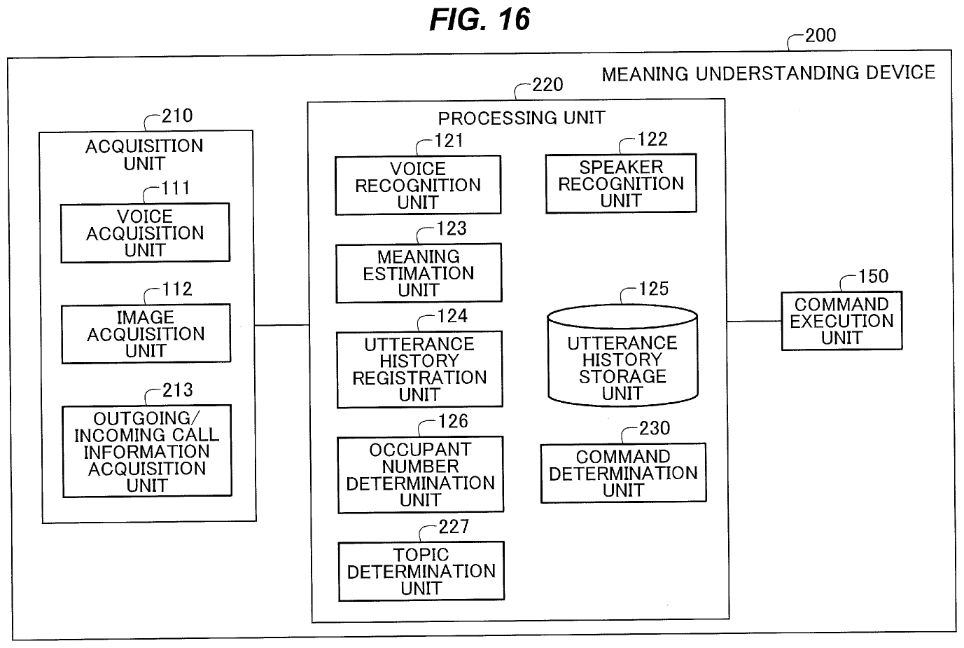

FIG. 16 is a block diagram schematically illustrating a configuration of a meaning understanding device 200 as an information processing device according to a second embodiment.

The meaning understanding device 200 includes an acquisition unit 210, a processing unit 220, and a command execution unit 150.

The command execution unit 150 of the meaning understanding device 200 according to the second embodiment is the same as the command execution unit 150 of the meaning understanding device 100 according to the first embodiment.

The acquisition unit 210 is an interface that acquires a voice, an image, and an outgoing/incoming call history.

The acquisition unit 210 includes a voice acquisition unit 111, an image acquisition unit 112, and an outgoing/incoming call information acquisition unit 213.

The voice acquisition unit 111 and image acquisition unit 112 of the acquisition unit 210 of the second embodiment are the same as the voice acquisition unit 111 and image acquisition unit 112 of the acquisition unit 110 of the first embodiment.

The outgoing/incoming call information acquisition unit 213 acquires outgoing/incoming call information indicating a history of outgoing and incoming calls, from a mobile terminal carried by a user. The outgoing/incoming call information acquisition unit 213 provides the outgoing/incoming call information to the processing unit 220.

The processing unit 220 uses the voice signal, image signal, and outgoing/incoming call information from the acquisition unit 210 to determine whether a voice of a user is a voice command for controlling an automotive navigation system that is a target.

The processing unit 220 includes a voice recognition unit 121, a speaker recognition unit 122, a meaning estimation unit 123, an utterance history registration unit 124, an utterance history storage unit 125, an occupant number determination unit 126, a topic determination unit 227, and a command determination unit 230.

The voice recognition unit 121, speaker recognition unit 122, meaning estimation unit 123, utterance history registration unit 124, utterance history storage unit 125, and occupant number determination unit 126 of the processing unit 220 of the second embodiment are the same as the voice recognition unit 121, speaker recognition unit 122, meaning estimation unit 123, utterance history registration unit 124, utterance history storage unit 125, and occupant number determination unit 126 of the processing unit 120 of the first embodiment.

The topic determination unit 227 determines a topic relating to the utterance indicated by an utterance information item that is a voice recognition result of the voice recognition unit 121.

The topic determination can be implemented by using a supervised machine learning method, such as an SVM.

Then, when the determined topic is a specific topic listed in a predetermined topic list, the topic determination unit 227 determines that the current user's utterance is a voice command that is a command for the automotive navigation system.

It is assumed that specific topics listed in the predetermined topic list are, for example, topics relating to utterances that are ambiguous in that it is difficult to determine whether it is an utterance for a person or an utterance for the automotive navigation system. Examples of the specific topics include a topic of “route guidance” or “air conditioner operation”.

For example, when the current user's utterance is “How many more minutes will it take to arrive” and the topic determination unit 227 determines a topic of “route guidance” as the topic of the current user's utterance, since the determined topic “route guidance” is listed in the predetermined topic list, the topic determination unit 227 determines that it is a command for the automotive navigation system.

With the above-described configuration, it is possible to always determine an utterance such that it is difficult to determine whether it is an utterance for a person or an utterance for the automotive navigation system to be a command for the automotive navigation system, and prevent it from being erroneously determined to be an utterance for a person.

The command determination unit 230 determines whether the currently input user's utterance is a voice command that is a command for the automotive navigation system, by using the utterance information item generated by the voice recognition unit 121, the speaker information item generated by the speaker recognition unit 122, the outgoing/incoming call information acquired by the outgoing/incoming call information acquisition unit 213, one or more immediately preceding records in the utterance history information stored in the utterance history storage unit 125, and the topic determined by the topic determination unit 227.

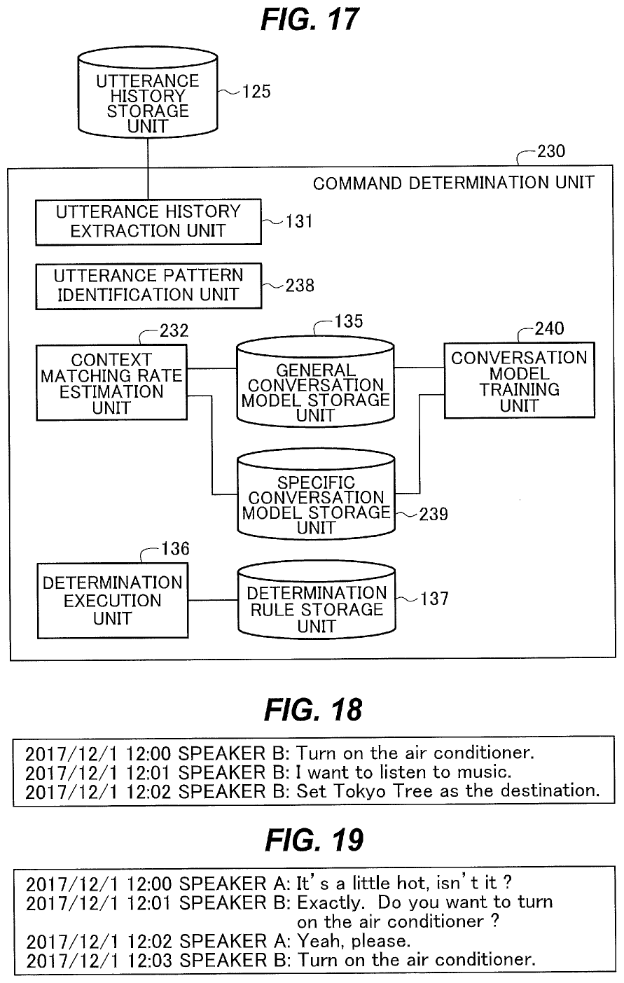

FIG. 17 is a block diagram schematically illustrating a configuration of the command determination unit 230.

The command determination unit 230 includes an utterance history extraction unit 131, a context matching rate estimation unit 232, a general conversation model storage unit 135, a determination execution unit 136, a determination rule storage unit 137, an utterance pattern identification unit 238, a specific conversation model storage unit 239, and a conversation model training unit 240.

The utterance history extraction unit 131, general conversation model storage unit 135, determination execution unit 136, and determination rule storage unit 137 of the command determination unit 230 of the second embodiment are the same as the utterance history extraction unit 131, general conversation model storage unit 135, determination execution unit 136, and determination rule storage unit 137 of the command determination unit 130 of the first embodiment.

The utterance pattern identification unit 238 identifies the pattern of an utterance group by using the utterance history information stored in the utterance history storage unit 125 and the outgoing/incoming call information acquired from the outgoing/incoming call information acquisition unit 213.

For example, the utterance pattern identification unit 238 determines a current utterance group from the utterance history information, and identifies the determined utterance group as one of the following first to fourth patterns.

The first pattern is a pattern in which only the driver is speaking. For example, the utterance group example illustrated in FIG. 18 is identified as the first pattern.

The second pattern is a pattern in which a fellow passenger and the driver are speaking. For example, the utterance group example illustrated in FIG. 19 is identified as the second pattern.

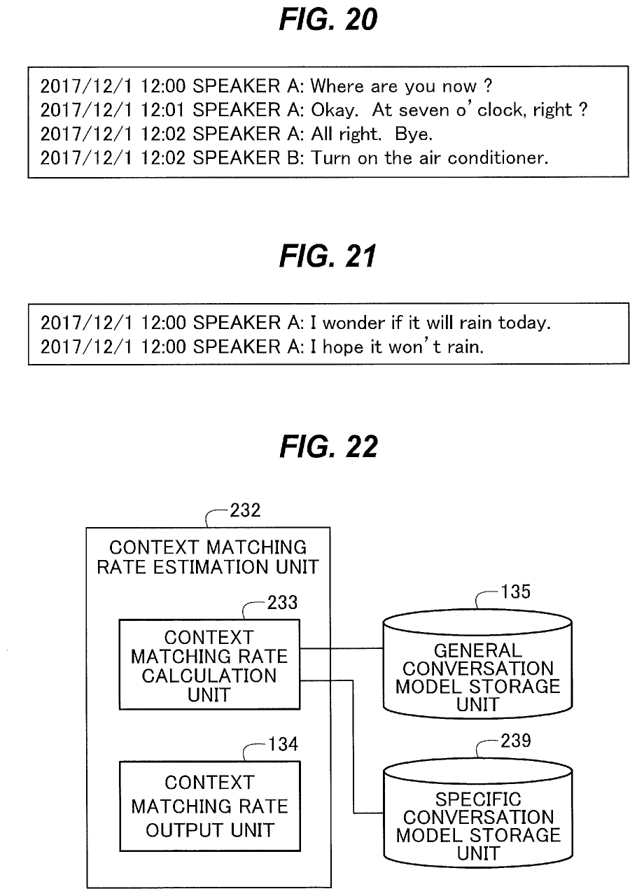

The third pattern is a pattern in which the driver is speaking while a fellow passenger is speaking on the phone. For example, the utterance group example illustrated in FIG. 20 is identified as the third pattern.

The fourth pattern is another pattern. For example, the utterance group example illustrated in FIG. 21 is the fourth pattern.

Specifically, the utterance pattern identification unit 238 extracts, from the utterance history information, records during a predetermined preceding time period, and determines whether only the driver is speaking, from the speakers corresponding to the respective utterances included in the extracted records.

When only the driver is speaking, the utterance pattern identification unit 238 identifies the current utterance group as the first pattern.

Also, when the speaker information items included in the extracted records show that multiple speakers exist, the utterance pattern identification unit 238 has a mobile terminal of a fellow passenger connected to the outgoing/incoming call information acquisition unit 213 through Bluetooth, wireless connection, or the like, and acquires the outgoing/incoming call information. In this case, the utterance pattern identification unit 238 may instruct the fellow passenger to connect the mobile terminal, by means of a voice, an image, or the like, through the command execution unit 150.

When the fellow passenger has had a phone conversation during the corresponding time, the utterance pattern identification unit 238 identifies the current utterance group as the third pattern.

On the other hand, when the fellow passenger has had no phone conversation during the corresponding time, the utterance pattern identification unit 238 identifies the current utterance group as the second pattern.

When the current utterance group is not any of the first to third patterns, the utterance pattern identification unit 238 identifies the current utterance group as the fourth pattern.

For the predetermined time period during which records are extracted from the utterance history information, an optimum value may be determined by experiment.

Further, when the utterance pattern identification unit 238 identifies the current utterance group as the first pattern, it determines that the current user's utterance is a voice command for the automotive navigation system.

On the other hand, when the utterance pattern identification unit 238 identifies the current utterance group as the fourth pattern, it determines that the current user's utterance is not a voice command for the automotive navigation system.

The specific conversation model storage unit 239 stores specific conversation model information representing a specific conversation model that is a conversation model used when the current utterance group is identified as the third pattern in which the driver is speaking while a fellow passenger is speaking on the phone.

When a fellow passenger is talking on the phone, since no voice of the conversation partner can be perceived, use of the general conversation model information may cause an erroneous determination. Thus, in such a case, by switching to the specific conversation model information, it is possible to improve the accuracy of the determination of a command for the automotive navigation system.

The context matching rate estimation unit 232 estimates a context matching rate between the current user's utterance and the utterances included in one or more records extracted from the utterance history storage unit 125, by using the general conversation model information stored in the general conversation model storage unit 135 or the specific conversation model information stored in the specific conversation model storage unit 239.

FIG. 22 is a block diagram schematically illustrating a configuration of the context matching rate estimation unit 232.

The context matching rate estimation unit 232 includes a context matching rate calculation unit 233 and a context matching rate output unit 134.

The context matching rate output unit 134 of the context matching rate estimation unit 232 of the second embodiment is the same as the context matching rate output unit 134 of the context matching rate estimation unit 132 of the first embodiment.

When the utterance pattern identification unit 238 identifies the current utterance group as the second pattern, the context matching rate calculation unit 233 calculates the context matching rate between the utterance input to the voice acquisition unit 111 and the utterances included in one or more immediately preceding records of the utterance history information stored in the utterance history storage unit 125, with reference to the general conversation model information stored in the general conversation model storage unit 135.

Also, when the utterance pattern identification unit 238 identifies the current utterance group as the third pattern, the context matching rate calculation unit 233 calculates the context matching rate between the utterance input to the voice acquisition unit 111 and the utterances included in one or more immediately preceding records of the utterance history information stored in the utterance history storage unit 125, with reference to the specific conversation model information stored in the specific conversation model storage unit 239.

Returning to FIG. 17, the conversation model training unit 240 trains the general conversation model from general conversations, and trains the specific conversation model from specific conversations.

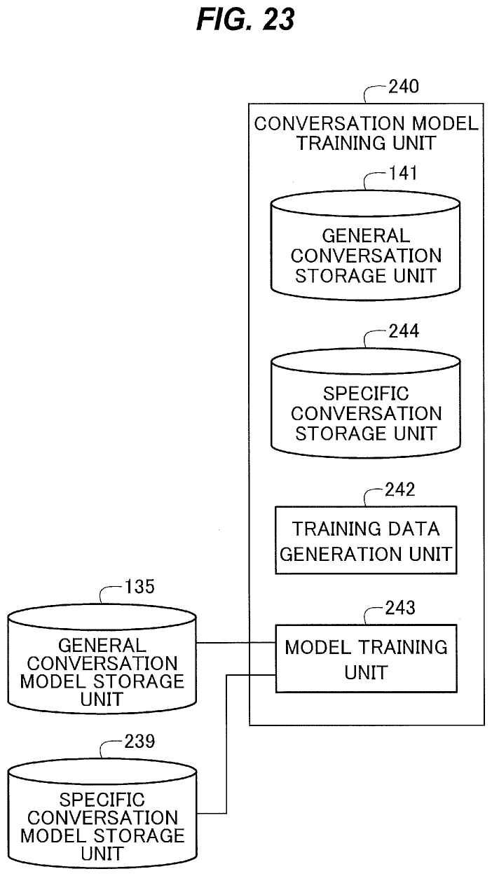

FIG. 23 is a block diagram schematically illustrating a configuration of the conversation model training unit 240.

The conversation model training unit 240 includes a general conversation storage unit 141, a training data generation unit 242, a model training unit 243, and a specific conversation storage unit 244.

The general conversation storage unit 141 of the conversation model training unit 240 of the second embodiment is the same as the general conversation storage unit 141 of the conversation model training unit 140 of the first embodiment.

The specific conversation storage unit 244 stores specific conversation information representing conversations when a driver is speaking while a fellow passenger is talking on the phone.

The training data generation unit 242 separates last utterances and immediately preceding utterances from the general conversation information stored in the general conversation storage unit 141, thereby converting it into a format of training data for general conversation.

Also, the training data generation unit 242 separates last utterances and immediately preceding utterances from the specific conversation information stored in the specific conversation storage unit 244, thereby converting it into a format of training data for specific conversation.

The model training unit 243 trains an encoder-decoder model by using the training data for general conversation generated by the training data generation unit 242 and stores, in the general conversation model storage unit 135, general conversation model information representing the trained model as a general conversation model.

Also, the model training unit 243 trains an encoder-decoder model by using the training data for specific conversation generated by the training data generation unit 242 and stores, in the specific conversation model storage unit 239, specific conversation model information representing the trained model as a specific conversation model.

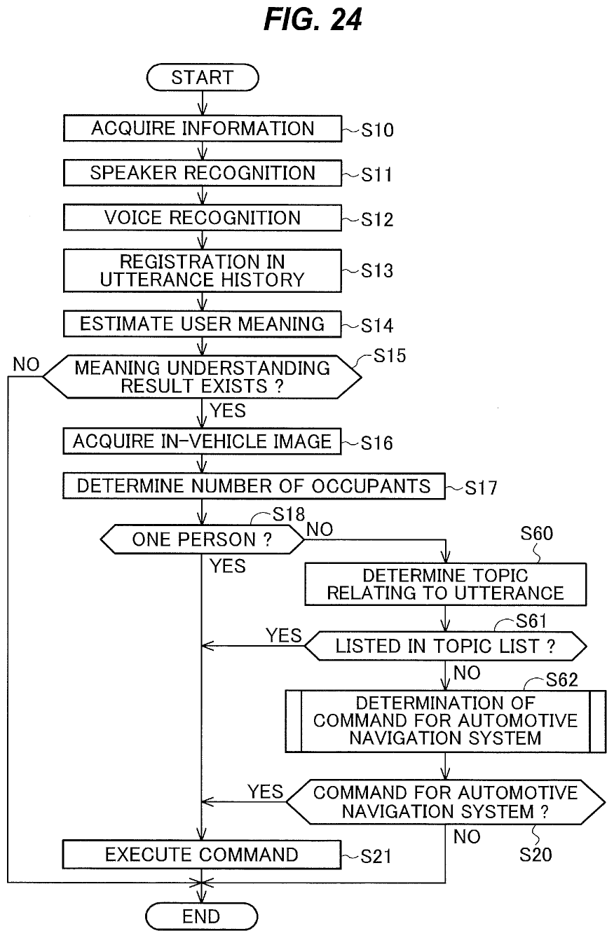

FIG. 24 is a flowchart illustrating the operation of a meaning estimation process by the meaning understanding device 200.

Of the processes included in the flowchart illustrated in FIG. 24, processes that are the same as those in the flowchart of the first embodiment illustrated in FIG. 7 will be given the same reference characters as in FIG. 7 and detailed description thereof will be omitted.

The processes of steps S10 to S18 illustrated in FIG. 24 are the same as the processes of steps S10 to S18 illustrated in FIG. 7. However, when the determination in step S18 is No, the process proceeds to step S60.

In step S60, the topic determination unit 227 determines a topic relating to the current user's utterance. For example, when the current user's utterance is “Is the next turn right?”, the topic determination unit 227 determines it to be a topic of “route guidance”. Also, when the current user's utterance is “Please turn on the air conditioner”, the topic determination unit 227 determines it to be a topic of “air conditioner operation”.

Then, the topic determination unit 227 determines whether the topic determined in step S60 is listed in the prepared topic list (S61). When the topic is listed in the topic list (Yes in S61), the process proceeds to step S21, and when the topic is not listed in the topic list (No in S61), the process proceeds to step S62.

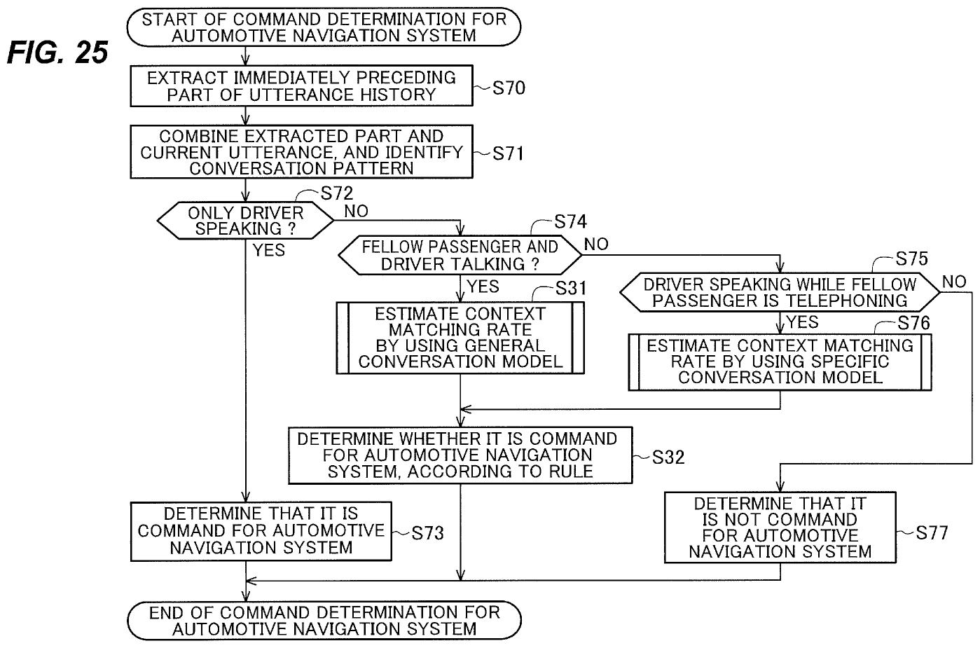

In step S62, the command determination unit 230 determines whether the meaning estimation result is a command for the automotive navigation system. The process of step S62 will be described in detail with reference to FIG. 25. The process then proceeds to step S20.

The processes of steps S20 and S21 in FIG. 24 are the same as the processes of steps S20 and S21 in FIG. 7.

As above, in the second embodiment, it is possible to always determine an utterance such that it is difficult to determine whether it is an utterance for a person or an utterance for the automotive navigation system, to be a voice command for the automotive navigation system, and prevent it from being erroneously determined to be an utterance for a person.

FIG. 25 is a flowchart illustrating the operation of a command determination process for the automotive navigation system.

Of the processes included in the flowchart illustrated in FIG. 25, processes that are the same as those in the flowchart of the first embodiment illustrated in FIG. 9 will be given the same reference characters as in FIG. 9 and detailed description thereof will be omitted.

First, the utterance history extraction unit 131 extracts, from the utterance history information stored in the utterance history storage unit 125, one or more immediately preceding records (S70). For example, the utterance history extraction unit 131 extracts records, such as the records during the preceding 10 seconds or the preceding 10 records, according to a predetermined rule. Then, the utterance history extraction unit 131 provides the utterance pattern identification unit 238 and context matching rate estimation unit 232 with the extracted records together with the utterance information item indicating the current user's utterance.

Then, the utterance pattern identification unit 238 combines the utterances included in the immediately preceding records and the current user's utterance, and identifies the utterance group pattern (S71).

Then, the utterance pattern identification unit 238 determines whether the identified utterance group pattern is the first pattern in which only the driver is speaking (S72). When the identified utterance group pattern is the first pattern (Yes in S72), the process proceeds to step S73, and when the identified utterance group pattern is not the first pattern (No in S72), the process proceeds to step S74.

In step S73, since the utterance group pattern is one in which only the driver is speaking, the utterance pattern identification unit 238 determines that the current user's utterance is a voice command for the automotive navigation system.

In step S74, the utterance pattern identification unit 238 determines whether the identified utterance group pattern is the second pattern in which a fellow passenger and the driver are talking. When the identified utterance group pattern is the second pattern (Yes in S74), the process proceeds to step S31. When the identified utterance group pattern is not the second pattern (No in S74), the process proceeds to step S75.

The processes of steps S31 and S32 illustrated in FIG. 25 are the same as the processes of steps S31 and S32 illustrated in FIG. 9.

In step S75, the utterance pattern identification unit 238 determines whether the identified utterance group pattern is the third pattern in which the driver is speaking while a fellow passenger is speaking on the phone. When the identified utterance group pattern is the third pattern (Yes in S75), the process proceeds to step S76. When the identified utterance group pattern is not the third pattern (No in S75), the process proceeds to step S77.

In step S76, the context matching rate estimation unit 232 estimates a context matching rate between the current user's utterance and the utterances included in the immediately preceding records, by using the specific conversation model information stored in the specific conversation model storage unit 239. The process here is performed according to the flowchart illustrated in FIG. 10 except for using the specific conversation model information stored in the specific conversation model storage unit 239. Then, the context matching rate estimation unit 232 provides the estimation result to the determination execution unit 136, and the process proceeds to step S32.

In step S77, since it is the fourth utterance group pattern, the utterance pattern identification unit 238 determines that the current user's utterance is not a voice command for the automotive navigation system.

The process of generating the specific conversation model information is performed according to the flowchart illustrated in FIG. 13 except that the specific conversation information stored in the specific conversation storage unit 244 is used. Detailed description thereof will be omitted.

As above, in the second embodiment, it is possible to identify the pattern of an utterance group including the current user's utterance, which is the last utterance, from among predetermined multiple patterns, with the utterance pattern identification unit, and change the method of determining whether the current user's utterance is a voice command, according to the identified pattern.

Also, in the second embodiment, the topic of the current user's utterance is determined by the topic determination unit 227. Then, when the determined topic is a predetermined specific topic, it is possible to determine the current user's utterance to be a voice command. Thus, by making the command determination unit 230 perform the determination process of determining whether the current user's utterance is a voice command only when the determined topic is not a predetermined specific topic, it is possible to reduce the calculation cost.

The above-described first and second embodiments have been described by taking an automotive navigation system as the application target. However, the application target is not limited to an automotive navigation system. The first and second embodiments are applicable to any devices that operate machines based on voice. For example, the first and second embodiments are applicable to smart speakers, air conditioners, and the like.

In the above-described first and second embodiments, the meaning understanding devices 100 and 200 include the conversation model training units 140 and 240. However, it is possible that the function of the conversation model training unit 140 or 240 is implemented by another device (such as a computer) and the general conversation model information or specific conversation model information is read into the meaning understanding device 100 or 200 through a network or a recording medium (not illustrated). In such a case, it is possible that an interface, such as a communication device, such as a network interface card (NIC), for connecting to a network, or an input device for reading information from a recording medium, is added as a hardware component in FIG. 5 or 6, and the information is acquired by the acquisition unit 110 or 210 in FIG. 1 or 16.

### DESCRIPTION OF REFERENCE CHARACTERS

100, 200 meaning understanding device, 110, 210 acquisition unit, 111 voice acquisition unit, 112 image acquisition unit, 213 outgoing/incoming call information acquisition unit, 120, 220 processing unit, 121 voice recognition unit, 122 speaker recognition unit, 123 meaning estimation unit, 124 utterance history registration unit, 125 utterance history storage unit, 126 occupant number determination unit, 227 topic determination unit, 130, 230 command determination unit, 131 utterance history extraction unit, 132, 232 context matching rate estimation unit, 133, 233 context matching rate calculation unit, 134 context matching rate output unit, 135 general conversation model storage unit, 136 determination execution unit, 137 determination rule storage unit, 238 utterance pattern identification unit, 239 specific conversation model storage unit, 140, 240 conversation model training unit, 141 general conversation storage unit, 142, 242 training data generation unit, 143, 243 model training unit, 244 specific conversation storage unit, 150 command execution unit.

What is claimed is:

1. An information processing device comprising:
processing circuitry
to acquire a voice signal representing voices corresponding to a plurality of utterances made by one or more users;
to recognize the voices from the voice signal, convert the recognized voices into character strings to identify the plurality of utterances, and identify times corresponding to the respective utterances;
to identify users who have made the respective utterances, as speakers from among the one or more users;
to store utterance history information including a plurality of records, the plurality of records indicating the respective utterances, the times corresponding to the respective utterances, and the speakers corresponding to the respective utterances;
to estimate meanings of the respective utterances;
to perform a determination process of referring to the utterance history information and when a last utterance of the plurality of utterances and one or more utterances of the plurality of utterances immediately preceding the last utterance are not a conversation, determining that the last utterance is a voice command for controlling a target; and
to, when it is determined that the last utterance is the voice command, control the target in accordance with the meaning estimated from the last utterance.

2. The information processing device of claim 1, wherein the processing circuitry calculates a context matching rate indicating a degree of matching between the last utterance and the one or more utterances in terms of context, and when the context matching rate is not greater than a predetermined threshold, determines that the last utterance and the one or more utterances are not a conversation.

3. The information processing device of claim 1, wherein the processing circuitry calculates a context matching rate indicating a degree of matching between the last utterance and the one or more utterances in terms of context, determines a weight that decreases the context matching rate as a time interval between the last utterance and the utterance immediately preceding the last utterance increases, and when a value obtained by correcting the context matching rate with the weight is not greater than a predetermined threshold, determines that the last utterance and the one or more utterances are not a conversation.

4. The information processing device of claim 2, wherein the processing circuitry calculates, as the context matching rate, a probability that the one or more utterances lead to the last utterance, by referring to a conversation model trained from conversations conducted by a plurality of users.

5. The information processing device of claim 1, wherein the processing circuitry identifies a pattern of an utterance group including the last utterance, from among a plurality of predetermined patterns, and
wherein how to determine whether the last utterance is the voice command depends on the identified pattern.

6. The information processing device of claim 1, wherein the processing circuitry
acquires an image signal representing an image of a space in which the one or more users exist,
determines, from the image, a number of the one or more users, and
performs the determination process when the determined number is not less than 2.

7. The information processing device of claim 6, wherein when the determined number is 1, the processing circuitry controls the target in accordance with the meaning estimated from the last utterance.

8. The information processing device of claim 1, wherein the processing circuitry
determines a topic of the last utterance and determines whether the determined topic is a predetermined specific topic, and
performs the determination process when the determined topic is not the predetermined specific topic.

9. The information processing device of claim 8, wherein when the determined topic is the predetermined specific topic, the processing circuitry controls the target in accordance with the meaning estimated from the last utterance.

10. An information processing method comprising:
acquiring a voice signal representing voices corresponding to a plurality of utterances made by one or more users;
recognizing the voices from the voice signal;
converting the recognized voices into character strings to identify the plurality of utterances;
identifying times corresponding to the respective utterances;
identifying users who have made the respective utterances, as speakers from among the one or more users;
estimating meanings of the respective utterances;
referring to utterance history information including a plurality of records, the plurality of records indicating the respective utterances, the times corresponding to the respective utterances, and the speakers corresponding to the respective utterances, and when a last utterance of the plurality of utterances and one or more utterances of the plurality of utterances immediately preceding the last utterance are not a conversation, determining that the last utterance is a voice command for controlling a target; and
when it is determined that the last utterance is the voice command, controlling the target in accordance with the meaning estimated from the last utterance.

11. A non-transitory computer-readable storage medium storing a program for causing a computer
to acquire a voice signal representing voices corresponding to a plurality of utterances made by one or more users;
to recognize the voices from the voice signal, convert the recognized voices into character strings to identify the plurality of utterances, and identify times corresponding to the respective utterances;
to identify users who have made the respective utterances, as speakers from among the one or more users;
to store utterance history information including a plurality of records, the plurality of records indicating the respective utterances, the times corresponding to the respective utterances, and the speakers corresponding to the respective utterances;
to estimate meanings of the respective utterances;
to perform a determination process of referring to the utterance history information and when a last utterance of the plurality of utterances and one or more utterances of the plurality of utterances immediately preceding the last utterance are not a conversation, determining that the last utterance is a voice command for controlling a target; and
to, when it is determined that the last utterance is the voice command, control the target in accordance with the meaning estimated from the last utterance.
